(19) United States
(12) Patent Application Publication
(10) Pub. No.: US 2015/0304200 A1
(43) Pub. Date: Oct. 22, 2015

(54) TRAFFIC INFORMATION COLLECTION SYSTEM AND COLLECTION CONTROL NODE

(71) Applicant: Hitachi, Ltd., Tokyo (JP)

(72) Inventors: Takahiro SAGARA, Tokyo (JP); Junji KINOSHITA, Tokyo (JP); Osamu TAKADA, Tokyo (JP)

(21) Appl. No.: 14/692,007

(22) Filed: Apr. 21, 2015

(30) Foreign Application Priority Data
Apr. 22, 2014 (JP) 2014-087835

(51) Int. Cl. H04L 12/26

(52) U.S. Cl. CPC H04L 43/0894

(57) ABSTRACT

In a traffic information collection system in which a collection node collecting collection information regarding traffic acquired by nodes on a network identifies a collection point of the collection information, a transmission node to transmit the collection information from a designated transmission port and a collection control node are included. The collection control node manages a connection relation of the transmission port of the transmission node and a reception IF of the collection node. The collection control node determines the reception IF of the collection node receiving the collection information acquired at a designated collection point of any node. The collection control node designates the transmission port connected to the determined reception IF with respect to the transmission node and outputs the collection information from the designated transmission port. The collection control node informs the collection node of correspondence information of the collection point and the reception IF.

### INCORPORATION BY REFERENCE

This application claims priority based on Japanese patent application No. 2014-087835 filed on Apr. 22, 2014, the entire contents of which are incorporated herein by reference.

### BACKGROUND

The subject matter disclosed herein relates to a method and system for collecting packets configuring traffic from a communication device and system.

In order to analyze information regarding traffic, that is, communication using packets, a monitor system or a security inspection system collects packets from a transfer node such as a switch or a router by a port mirroring and collects the information regarding the traffic (hereinafter, referred to as collection information). A data center generally introduces such a system (hereinafter, referred to as a collection function), from the viewpoint of operation management or security.

In the recent data center, a multipath network or policy based routing is introduced and a path of the transfer node which the traffic passes through dynamically may change. If the path changes, a place (a port of the transfer node; hereinafter referred to as a collection point) to be a collection target of information also changes. However, because performance of the collection function is limited, it is difficult to collect information from all places at all times. For this reason, technology for changing the collection points dynamically, that is, without stopping an entire system, to collect necessary information from the small collection points, is demanded.

For example, WO 2011/118575 A1 discloses a method of determining collection points on the basis of statistical information and starting detailed information collection by traffic monitor technology (monitor technology of packet communication) determined by IETF RFC3176 (refer to a paragraph [0028]). In the monitor technology, because an identifier showing the collection point is added as a header to collection information, the collection function can identify the collection point of the acquired collection information, even when the collection point dynamically changes.

### SUMMARY

In the traffic monitor technology, the identifier showing the collection point is newly added to the collection information. In the case of the method, the collection function side and the monitor function side need to have a function of adding the identifier and a function of analyzing the identifier, respectively. For this reason, a process load increases.

Meanwhile, in a method of collecting the packets by the known port mirroring, the identifier showing the collection point is not added to the collection information. When the information to which the identifier is not added is collected by changing the collection point dynamically, the collection function cannot identify the collection point of the collection information. For this reason, a problem occurs when the collection information is used.

Accordingly, technology for identifying the collection point of the collected information with a simple configuration without increasing the process load, even when the collection point can be changed, is demanded. Specifically, technology for identifying the collection point, even when the identifier showing the collection point is not given to the collected information, is demanded.

The disclosed collection technology and the collection system using the same identify a collection point of collection information at the collection function side without giving information of the collection point to the collection information.

The disclosed traffic information collection system may include a collection control function. The collection control function manages a connection relation of a transmission port of a transmission node connected to a reception interface (hereinafter, the interface is referred to as an IF) of a collection function and transmitting collection information and the reception IF of the collection function. The collection control function designates the transmission port to the transmission node designating the transmission port, outputs specific collection information to arrive at a specific reception IF, and informs the collection function of correspondence information of a collection point and the reception IF.

The transmission node to be the designation target of the transmission port may be at least one of the same node as a transfer node acquiring the collection information and a transfer node for collection configuring a collection network connecting the transfer node and the collection function. The collection control function manages a connection relation of information specifying the collection point of the received or acquired collection information and a reception port (that is, the reception IF) becoming the connection destination of the transmission port of the collection information, for the transmission node not to be the designation target of the transmission port.

As a result, the collection function identifies the collection point of the collection information, on the basis of the reception IF having received the collection information and the correspondence information informed by the collection control function.

In addition, at least one of the collection control function and the collection function may be an independent node.

According to the teaching herein, a collection function can identify a collection point of collection information, without giving information of the collection point to the collection information.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a schematic configuration of a traffic information collection system;

FIG. 2 illustrates an example of a hardware configuration of a collection function and a collection control function;

FIG. 3 illustrates an example of a collection network;

FIG. 4 illustrates an example of association information included in a collection control node;

FIG. 5 illustrates an example of correspondence information and reception IF information;

FIG. 6 illustrates an example of a sequence to control a transmission destination of collection information with respect to a transfer node;

FIG. 7 illustrates an example of a process for determining a reception IF to be a destination;

FIG. 8 illustrates an example of a sequence to perform control to stop a transmission process of collection information from a transfer node;

FIG. 9 illustrates an example of a sequence to receive collection information by a collection function;

FIG. 10 illustrates an example of a collection network according to a second embodiment;

FIG. 11 illustrates an example of a table included in a collection control function according to the second embodiment;

FIG. 12 illustrates an example of a sequence to control a transmission destination of collection information with respect to a transfer node for collection, in the second embodiment;

FIG. 13 illustrates an example of a table included in a collection control function according to a third embodiment;

FIG. 14 illustrates an example of a process for determining a reception IF to be a destination, in the third embodiment;

FIG. 15 illustrates an example of a configuration of a packet collection method according to a fourth embodiment;

FIG. 16 illustrates an example of a table included in a collection function according to the fourth embodiment;

FIG. 17 illustrates an example of a process for determining a reception IF to be a destination, in the fourth embodiment; and

FIG. 18 illustrates an example of the case of identifying a collection point corresponding to collection information, in the fourth embodiment.

### DESCRIPTION OF THE EMBODIMENTS

Hereinafter, embodiments will be described using the drawings. In the following embodiments, an example of the case in which different devices include a collection function and a collection control function, respectively, will be described. However, one device may include the collection function and the collection control function and each function may be configured by a plurality of devices. In addition, in the following embodiments, an example of the case in which a collection network and a control network are different from each other will be described. However, the collection network and the control network may be the same communication medium physically.

In addition, in the following embodiments, a reception IF and a transmission IF included in a node may be represented as a reception port and a transmission port, respectively.

### First Embodiment

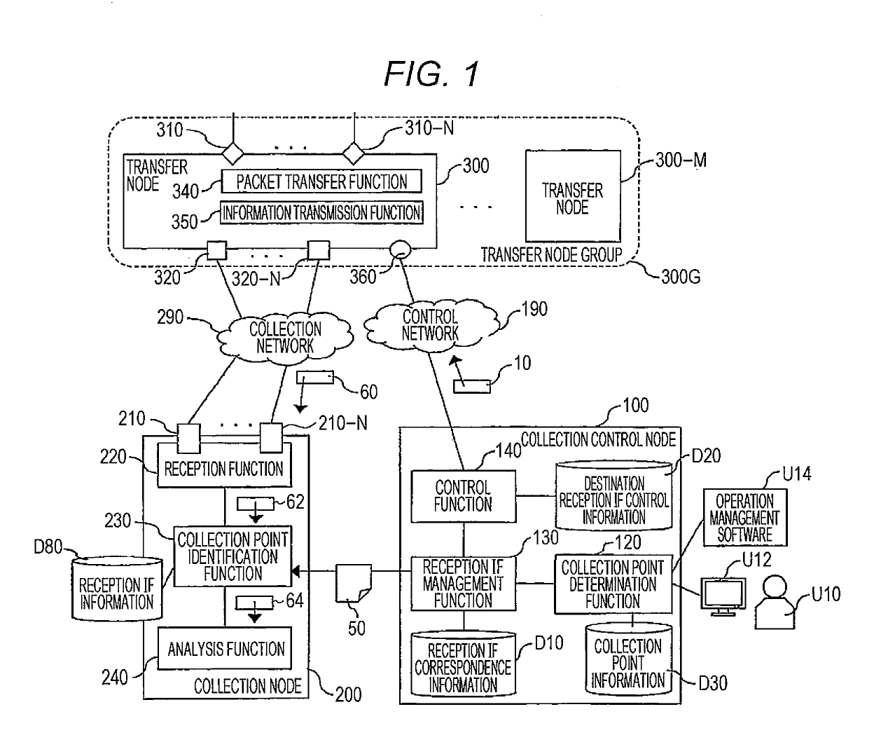

As illustrated in FIG. 1, a collection system according to this embodiment includes a transfer node group 300G that is a collection of one or more transfer nodes 300 to 300-M, a collection node 200 that is connected to the transfer node group 300G through a collection network 290 and configures a collection function, and a collection control node 100 that is connected to the transfer node group 300G through a control network 190 and configures a collection control function. The transfer nodes 300 to 300-M are local area network (LAN) switches, for example. Transmission nodes in this embodiment are the transfer nodes 300 to 300-M.

Each of the transfer nodes 300 to 300-M includes one or more collection points 310 to 310-N, one or more transmission ports 320 to 320-N, a control interface (hereinafter, referred to as a control IF) 360, a packet transfer function 340, and an information transmission function 350. The collection points 310 to 310-N are connected to other transfer node or an electronic computer by a communication cable.

The packet transfer function 340 analyzes packets received by the collection points 310 to 310-N and transmits the packets from the appropriate collection points 310 to 310-N. The information transmission function 350 acquires copies of the packets received by the collection points 310 to 310-N, the transmitted packets, or both the received packets and the transmitted packets, generates collection information 60 including the acquired copies, and transmits the collection information from the transmission ports 320 to 320-N designated in advance.

The control IF 360 is an IF that receives a command to the information transmission function 350 and transmits a result. These functions included in the transfer nodes 300 to 300-M are known and are included in a general LAN switch. For example, the information transmission function 350 corresponds to a port mirroring function and the transmission port 320 corresponds to a mirroring port.

In this embodiment, the case in which the information transmission function 350 transmits the copied packets as the collection information 60 is described. However, a part of the packets, statistical information, or other information may be transmitted as the collection information 60. In addition, one collection point 310 may be a plurality of ports physically.

The collection control node 100 includes a collection point determination function 120, a control function 140, a reception IF management function 130, reception IF correspondence information D10, destination reception IF control information D20, and collection point information D30.

The collection point determination function 120 determines which collection point information is collected from. For example, the collection point determination function 120 displays a list of designatable collection points 310 to 310-N for a user U10 through an input/output terminal U12, allows the user U10 to select the collection point, and determines the collection point. The list of designatable collection points is generated on the basis of the collection point information D30 to be described below.

In this embodiment, an example of the case in which the user U10 selects the collection point directly is described. However, operation management software U14 may determine the collection point. Specifically, the collection point determination function 120 includes an application programming interface (API) that can perform communication with a hypertext transfer protocol (HTTP). The operation management software U14 selects the collection point through the API and informs the collection point determination function 120 of the collection point. At this time, the operation management software U14 may determine the collection point, on the basis of predetermined correspondence of the electronic computer and the collection point, according to operation information of an application or a virtual machine operating on the electronic computer connected to the transfer nodes 300 to 300-M.

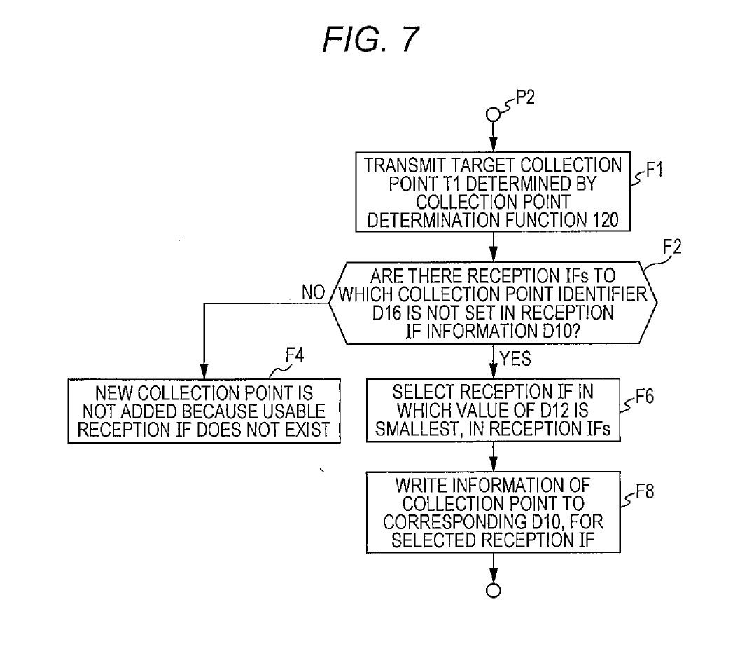

The reception IF management function 130 determines the reception IFs 210 to 210-N of the collection node 200 receiving the collection information 60 of the collection point 310, on the basis of the reception IF correspondence information D10, updates information of the reception IF correspondence information D10, and informs the control function 140 of an identifier of the reception IF. This process will be described in P2 of FIG. 7 hereinafter. In addition, the reception IF management function 130 generates correspondence information 50, on the basis of the reception IF correspondence information D10, and informs the collection point identification function 230 of the correspondence information 50.

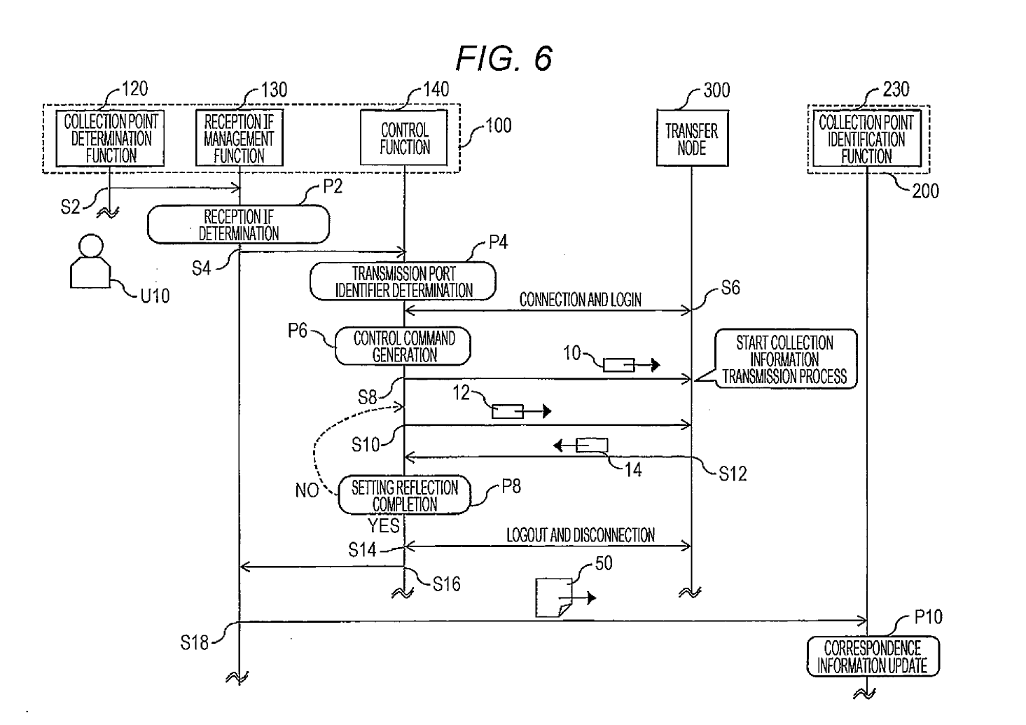

The control function 140 generates a control command to designate the collection point and the transmission port, on the basis of the destination reception IF control information D20, such that the collection information 60 collected at the collection point determined by the collection point determination function 120 is transmitted from the transmission ports 320 to 320-N associated with the reception IFs 210 to 210-N determined by the reception IF management function 130, and transmits the control command 10 to the control IF 360 of the transfer node to be the transmission node. This process will be described in P6 of FIG. 6 hereinafter.

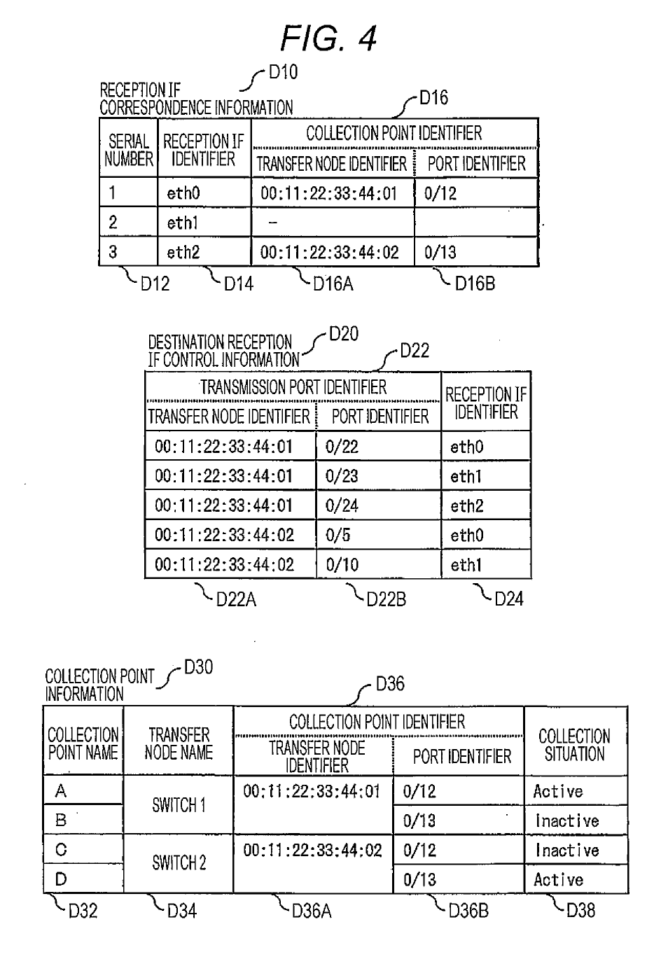

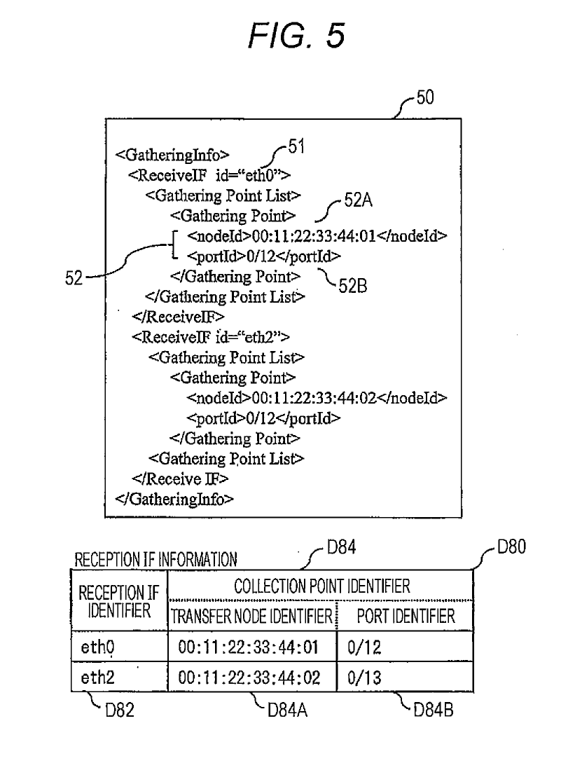

Items included in the reception IF correspondence information D10, the destination reception IF control information D20, the collection point information D30, and the correspondence information 50 will be described below using FIGS. 4 and 5.

The collection node 200 includes one or more reception IFs 210 to 210-N, a reception function 220, a collection point identification function 230, an analysis function 240, and reception IF information D80. The reception function 220 receives the collection information 60 transmitted from the transmission ports 320 to 320-N of the transfer node group 300G, through the collection network 290 by the reception IFs 210 to 210-N.

The reception function 220 identifies which of the reception IFs 210 to 210-N the received collection information 60 is received through, adds an identifier of the reception IF, which the collection information 60 is received through, to the collection information 60, and delivers the corresponding information as collection information 62 to the collection point identification function 230. A method of identifying the reception IF 210 by the reception function 220 is known. For example, in a program, because the reception IF is designated and the packets are received, the reception IF having received the packets can be specified.

The collection point identification function 230 receives correspondence information 50 from the reception IF management function 130 of the collection control node 100 and sets the reception IF information D80 In addition, the collection point identification function 230 receives collection information 62 from the reception function 220, determines the collection point corresponding to the reception IF identifier included in the collection information 62, on the basis of the reception IF information D80, adds the collection point identifier to the collection information 62, and delivers the corresponding collection information as collection information 64 to the analysis function 240.

The analysis function 240 receives the collection information 64 and stores collection information in a database for each collection point or displays information for the user U10 for each collection point, on the basis of the collection point identifier to which the collection point identification function 230 has been added. A specific process after the analysis function 240 identifies the collection point is not limited in this embodiment and known technology is used.

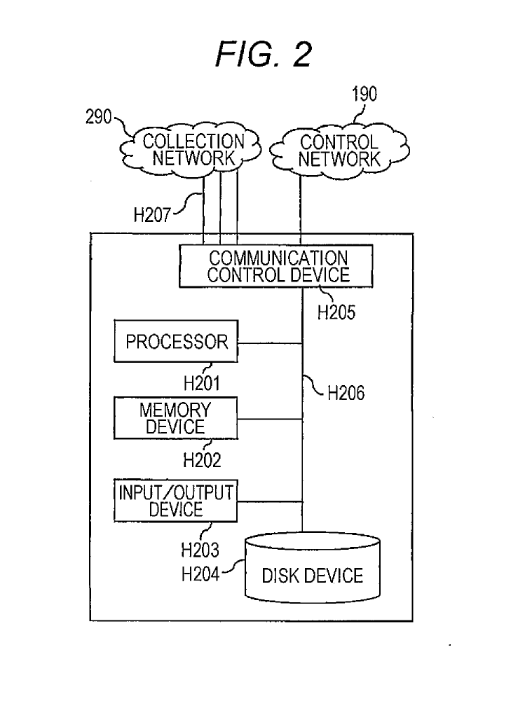

FIG. 2 illustrates a physical configuration of the electronic computer realizing the collection control node 100 and the collection node 200. The electronic computer according to this embodiment includes a processor H201 to execute a program and realize each process function, a memory device H202 to temporarily store executed program or data, an input device H203 to input an instruction or information from the outside, a disk device H204 to store a substance, an instruction, and information of a program and to be used as a storage unit of data, a communication control device H205 to control an exchange of data with an external device, an internal communication line H206 such as a bus to perform an exchange of data in the device, and an external communication line H207 to perform an exchange of data between an internal device and an external device of the electronic computer.

The program may be previously stored in the memory device H202 or the disk device H204 in the electronic computer and may be introduced from a removable recording medium usable by the electronic computer or may be acquired from other device through a carrier (network, wave propagating through a network, or a digital signal) if necessary.

In addition, process content of each function described in this embodiment is realized by reading and executing the program stored in the disk device H204 by the processor H201.

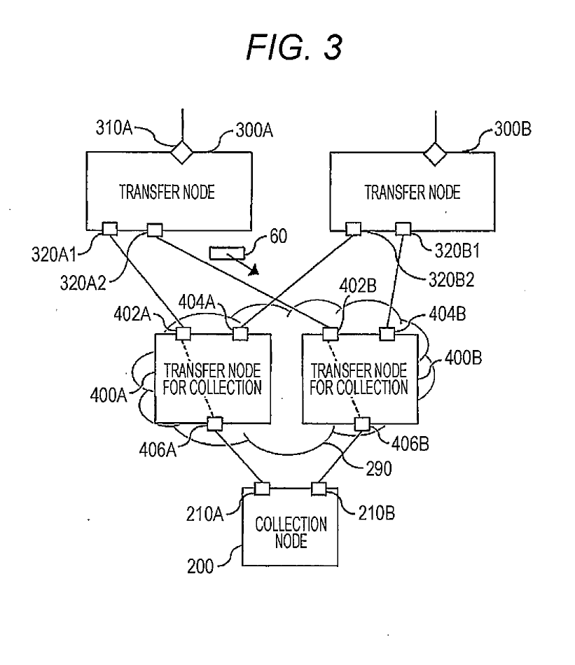

FIG. 3 illustrates an example of a collection network 290 connecting the transfer node group 300G and the collection node 200. The collection network 290 includes transfer nodes 400 for collection of which the number is equal to the number of reception IFs 210 to 210-N of the collection node 200. In addition, the transfer node 400 for the collection includes reception ports 402A and 404A of which the number is equal to or more than the number of transfer nodes and one transmission port 406A. In FIG. 3, the two transfer nodes 300, the two reception IFs of the collection node 200, and the two transfer nodes 400 for the collection are illustrated to simplify the description. However, the number of each of the transfer nodes and the reception IFs may be three or more, as long as the transfer node 400 for the collection satisfies the condition.

The reception ports 402A, 404A, 402B, and 404B, for example, are connected to transmission ports 320A1, 320B1, 320A2, and 320B2, respectively, such that the transfer nodes 400A and 400B for the collection are connected to all transfer nodes. The transfer ports 406A and 406B of the transfer nodes 400A and 400B for the collection are connected to reception Ifs, for example, 210A and 210B, respectively, to be connected to the reception IFs of the collection node 200. In addition, the transfer nodes 400A and 400B for the collection transmit the packets received by the reception ports 402A and 402B from the transmission ports 406A and 406B, respectively, according to setting. The technology of the transfer node for the collection is general and a LAN switch is included, for example.

In the collection network 290 configured as described above, the collection control node 100 manages a connection relation of the transmission port 320 of the transfer node 300 and the reception port 402 of the transfer node 400 for the collection, a correspondence relation of the reception port 402 of the packets of the transfer node 400 for the collection and the transmission port 406 thereof, and a connection relation of the transmission port 406 of the transfer node 400 for the collection and the reception IF 210 of the collection node 200.

In such a configuration, for example, when the collection information 60 of the collection point 310A is received by the reception IF 210A of the collection node 200, the collection information is transmitted from the transmission port 320A1, on the basis of the managed connection relation. In this case, in the transfer node 400A for the collection, the reception port 402A receives the collection information 60 and transmits the collection information from the transmission port 406A. As a result, the collection node 200 can receive the collection information 60 by the reception IF 210A.

In addition, when the collection information 60 of the collection point 310A is received by the reception IF 210B, the collection information is transmitted from the transmission port 320A2. In this case, in the transmission node 400B for the collection, the reception port 402B receives the collection information 60 and transmits the collection information from the transmission port 406B. As a result, the collection node 200 can receive the collection information 60 by the reception IF 210B.

As such, in the configuration of the collection network 290, the control function 140 of FIG. 1 controls the transmission ports 320 to 320-N through which the transfer nodes 300 to 300-M transmit the collection information 60, so that the collection node 200 can control the reception IFs 210 to 210-N receiving the collection information 60.

FIG. 4 illustrates an example of the reception IF correspondence information D10, the destination reception IF control information D20, and the collection point information D30 included in the collection control node 100.

The reception IF correspondence information D10 includes a serial number D12, a reception IF identifier D14, and a collection point identifier D16 as associated items.

The serial number D12 is a unique numeral and a serial number starting from 1 is used in this embodiment.

The reception IF identifier D14 is an identifier to identify the reception IFs 210 to 210-N uniquely. In this embodiment, a name of a network interface card (NIC) is used. However, when the plurality of collection nodes 200 exist and the reception IFs 210 to 210-N of the reception function 220 exist, a combination of the identifier of the electronic computer and the name of the NIC is used as the reception IF identifier.

The collection point identifier D16 is an identifier to identify the collection point uniquely. In this embodiment, the collection point identifier D16 is a combination of a transfer node identifier D16A and a port identifier D16B.

For example, the transfer node identifier D16A is a unique media access control (MAC) address of the transfer node and the port identifier D16B is an identifier of a switch port number format represented by a “module number/port number” to identify a port of a switch. The collection point identifier D16 is not set until the collection point identifier is set by the reception IF management function 130.

When the collection point identifier D16 is set, this shows that the collection information 60 of the collection point is being transmitted to the reception IF shown by the corresponding reception IF identifier D14.

In the serial number D12 and the reception IF identifier D14 of the reception IF correspondence information D10, values thereof are set previously according to the reception IFs 210 to 210-N of the collection node 200. The setting may be carried out manually or may be carried out using a known configuration management tool. The collection point identifier D16 is set by the reception IF management function 130.

The reception IF correspondence information D10 includes records to correspond to all of the reception IFs 210 to 210-N.

The destination reception IF control information D20 includes association information of a transmission port identifier D22 and a reception IF identifier D24.

The transmission port identifier D22 is identifiers of the transmission ports 320 to 320-N included in the transfer nodes 300 to 300-M, including a transfer node identifier D22A and a port identifier D22B. Specifically, the transmission port identifier D22 is a MAC address and is an identifier of a port number format, similar to the collection point identifier D16.

The destination reception IF control information D20 includes records to correspond to all of the transmission ports 320 to 320-N.

The reception IF identifier D24 is identifiers showing the reception IFs 210 to 210-N. In the reception IF identifier D24, a value thereof is set previously according to a combination of the transmission ports 320 to 320-N and the reception IFs 210 to 210-N connected through the collection network 290. The setting may be carried out manually or may be carried out using a known configuration management tool.

When the collection network 290 connecting the transfer node group 300G and the collection node 200 includes the transfer nodes 400A and 400B for the collection illustrated in FIG. 3, the destination reception IF control information D20 is set in consideration of a correspondence relation of the reception ports and the transmission ports of the transfer nodes 400A and 400B for the collection.

The collection point information D30 includes association information of a collection point name D32, a transfer node name D34, a collection point identifier D36, and a collection situation D38.

The collection point name D32 is a unique name between the collection points that can be understood by the user U10.

The transfer node name D34 is a unique name between the transfer nodes that can be understood by the user U10. The collection point name D32 and the transfer node name D34 are set manually in advance and facilitates identification when the user selects the collection point.

The collection point identifier D36 is an identifier to identify the collection point uniquely and has the same format as the format of the collection point identifier D16.

The collection situation D38 is a flag showing whether the corresponding collection point identifier D36 exists in the collection point identifier D16 of the reception IF correspondence information D10. In this embodiment, the case in which the corresponding collection point identifier D36 exists is represented as “Active” and the case in which the corresponding collection point identifier D36 does not exist is represented as “Inactive”.

The collection point information D30 includes records to correspond to all of the collection points 310 to 310-N.

FIG. 5 illustrates an example of the correspondence information 50 which the reception IF management function 130 informs the collection point identification function 230 of and the reception IF information D80 set by the collection point identification function 230 on the basis of the correspondence information 50. In this embodiment, an example of the case in which the correspondence information 50 is described in an extensible markup language (XML) is illustrated. However, the correspondence information 50 may be described in other format.

The correspondence information 50 includes a set of the reception IF identifier D14 to which the collection point identifier D16 in the reception IF correspondence information D10 has been set and the collection point identifier D16 as a set of the reception IF identifier 51 and the collection point identifier 52.

The reception IF information D80 includes a set of the reception IF identifier 51 informed by the correspondence information 50 and the collection point identifier 52 as a set of the reception IF identifier D82 and the collection point identifier D84.

FIG. 6 illustrates an example of a sequence to control the transfer node 300 by the collection control node 100 to transmit the collection information 60 from the transfer node 300 to the specific reception IF of the reception function 220.

The collection point determination function 120 provides information of the collection points to the user U10 through the input/output terminal U12. The provided information is a list of the collection point name D32, the transfer node name D34, and the collection point identifier included in the collection point information D30.

The user U10 selects any collection point from the information of the collection points provided by the collection point determination function 120.

Hereinafter, the selected collection point identifier is referred to as a target collection point identifier T1, a transfer node identifier included in the target collection point identifier is referred to as a target transfer node identifier T1N, and a port identifier included in the target collection point identifier is referred to as a target collection port identifier T1P. In addition, a transfer node shown by the target transfer node identifier T1N is referred to as a target transfer node TINE and a collection port shown by the target collection port identifier T1P is referred to as T1PE.

The collection point determination function 120 updates a value of the collection situation D38 corresponding to the target collection point identifier T1 of the collection point information D30 with “Active” and informs the reception IF management function 130 of the target collection point identifier T1 (S2). When the value of the collection situation D38 corresponding to the target collection point identifier T1 is already “Active”, the collection information 60 is being acquired from the collection point shown by the target collection point identifier T1. For this reason, the process after S2 is not executed and the user is informed of information showing that the process is not necessary.

The reception IF management function 130 determines the reception IFs 210 to 210-N to be the destinations of the collection information 60, according to P2 of FIG. 7 to be described below, on the basis of the target collection point identifier T1. The determined reception IFs are referred to as destination reception IFs. The reception IF management function 130 sets a value of the target collection point identifier T1 to the collection point identifier D16 corresponding to the destination reception IF in the reception IF correspondence information D10. In addition, the reception IF management function 130 informs the control function 140 of the destination reception IF identifier and the target collection point identifier T1 (S4).

The control function 140 sets the port identifier D22B of records including the informed destination reception IF identifier in the reception IF identifier D24 and including the target transfer node identifier T1N in the transfer node identifier D22A in the destination reception IF control information D20 as a target transmission port identifier T2P (P4). The transmission port shown by the target transmission port identifier T2P is set as a target transmission port T2PE.

The control function 140 establishes communication using a predetermined method with respect to the target transfer node TINE and executes the login (S6). In this embodiment, the target transfer node TINE is set as the transfer node 300. The predetermined method is Telnet, for example. In addition, an IP address of the target transfer node 300 necessary for communication establishment and information of a login name and a password necessary for the login are set manually and the control function 140 includes the IP address and the information. In this embodiment, an example of the case in which the login is necessary for control of the transfer node 300 is described. However, if the login is not necessary, the login and the logout may not be executed.

The control function 140 generates a control command 10 to acquire copies of packets transmitted and received by the target collection port T1PE, understood by the information transmission function 350 of the transfer node 300, and transmit the copies from the target transmission port T2PE (P6). The control command 10 includes the target collection port identifier T1P and the transmission port identifier T2P according to a format previously determined by the transfer node 300.

In this embodiment, the copies of the packets transmitted and received by the collection port are used as the collection information 60. However, statistical information regarding traffic, that is, packet communication received or transmitted by the collection port by the information transmission function 350, a part of the packets, and a resultant obtained by processing the packets may be used as the collection information 60. In addition, the control command 10 may be configured by a combination of a plurality of commands.

The control function 140 transmits the generated control command 10 to the transfer node 300 (S8). The transfer node 300 having received the control command 10 starts a process for transmitting the collection information 60 of the target collection port T1PE shown by the control command 10 from the target transmission port T2PE shown by the control command 10 (hereinafter, referred to as a collection information transmission process).

The control function 140 transmits a collection situation confirmation command 12 to the transfer node 300 to confirm whether the transfer node 300 starts the collection information transmission process according to the command of the control command 10 (S10). This is because constant time or more is necessary until the transfer node 300 starts the process of the collection information transmission process.

If the transfer node 300 receives the collection situation confirmation command 12, the transfer node 300 transmits a collection situation 14 regarding the collection information transmission process as a reply. The collection situation is a list of combinations of collection port identifiers and transmission port identifiers during the execution of the collection information transmission process (S12).

The control function 140 determines whether the collection information transmission process designated by the control command 10 is executed, in the received collection situation 14 (P8).

If the collection information transmission process is not executed, the routine is repeated from the process of S10 after predetermined time.

If the collection information transmission process designated by the control command 10 is executed, the logout is executed from the transfer node 300 and communication is interrupted (S14).

Then, the control function 140 informs the reception IF management function 130 of the moment of transmission of the correspondence information 50 (S16).

The reception IF management function 130 receives the information of the moment, generates the correspondence information 50 using the set of the target collection point identifier T1 and the destination reception IF determined by P2 as the set of the collection point identifier 52 and the reception IF identifier 51, and informs the collection point identification function 230 of the correspondence information (S18).

The collection point identification function 230 stores the set of the collection point identifier 52 and the reception IF identifier 51 shown by the received correspondence information 50 in the reception IF information D80 (P10).

FIG. 7 illustrates an example of a process P2 for determining the destination reception IF by the reception IF management function 130.

The target collection point identifier T1 is transmitted from the collection point determination function 120 to the reception IF management function 130 (F1).

The reception IF management function 130 determines whether the reception IF identifier D14 (hereinafter, referred to as a usable reception IF) to which the collection point identifier D16 is not set exists, in the reception IF correspondence information D10 (F2).

When the usable reception IF does not exist (NO in F2), a new collection point cannot be set because the usable reception IF does not exist. For this reason, the process after P2 is not executed (F4). At this time, the reception IF management function may inform the user U10 of information showing that the usable reception IF does not exist, through the input/output terminal U12.

When one or more usable reception IFs exist (YES in F2), the reception IF management function 130 selects one usable reception IF from the usable reception IFs, according to a predetermined rule, and sets the usable reception IF as a destination reception IF. In this embodiment, a rule of selecting the serial number D12 of a smallest value is adopted and the reception IF identifier D14 in which a value of the serial number D12 is smallest is selected (F6). The rule is exemplary and other rule may be adopted.

The reception IF management function 130 writes information of the target collection point identifier T1 determined by the collection point determination function 120 to the collection point identifier D16 of the record including the destination reception IF identifier in the reception IF correspondence information D10 (F8).

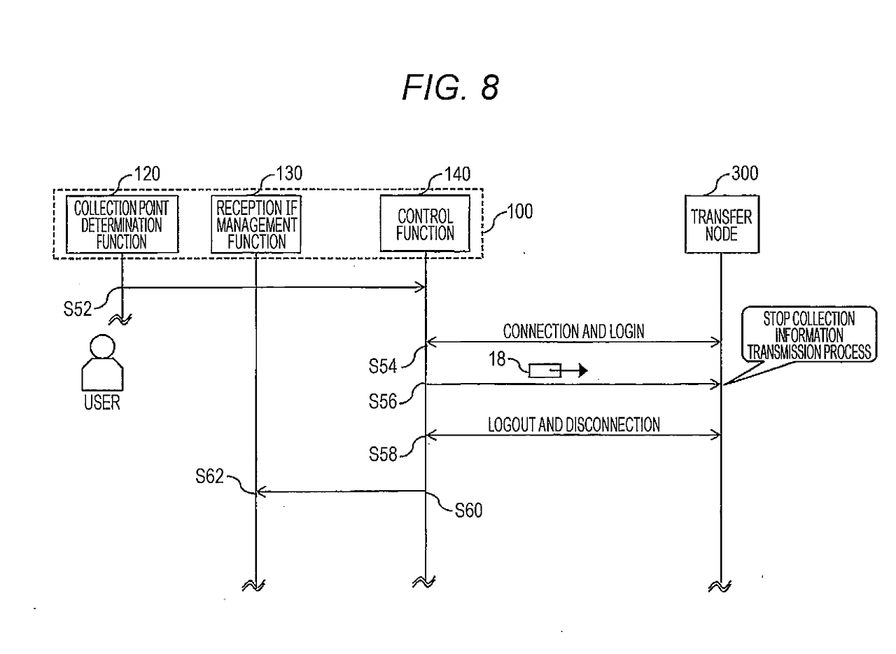

FIG. 8 illustrates an example of a sequence to control the transfer node 300 by the collection control node 100 to stop the collection information transmission process in the collection point of the transfer node 300.

The collection point determination function 120 provides information of a collection point in which a value of the collection situation D38 is “Active” in the collection point information D30 to the user U10, through the input/output terminal U12. The provided information is a list of the collection point name D32, the transfer node name D34, and the collection point identifier included in the collection point information D30.

The user U10 selects a collection point to stop the acquisition of the collection information 60, from the provided collection point list. Hereinafter, an identifier of the selected collection point is set as the target collection point identifier T1, a transfer node identifier included in the target collection point identifier is set as the target transfer node identifier T1N, and a port identifier included in the target collection point identifier is set as the target collection port identifier TIP. In addition, the a transfer node shown by the target transfer node identifier T1N is set as the target transfer node TINE and a collection port shown by the target collection port identifier TIP is set as the target collection port T1PE.

The collection point determination function 120 sets the collection situation D38 of the record including the target collection point identifier T1 in the collection point identifier D36 in the collection point information D30 as “Inactive” and informs the control function 140 of the target collection point identifier T1 (S52).

Similar to S6 of FIG. 6, the control function 140 establishes communication with respect to the target transfer node TINE informed by the collection point determination function 120 and executes the login (S54). In this embodiment, the target transfer node TINE is set as the transfer node 300.

The control function 140 generates a control command 18 to stop the collection information transmission process of the target collection point T1PE that can be understood by the information transmission function 350 of the target transfer node 300. The control command 18 includes the target collection port identifier T1P according to the format previously determined by the transfer node 300. The control command 18 may be configured by a combination of a plurality of commands. The control function 140 transmits the generated control command 18 to the transfer node 300.

The transfer node 300 having received the control command 18 stops the collection information transmission process in the target collection port T1PE shown by the control command 18 (S56).

After transmitting the control command 18, the control function 140 executes the logout from the transfer node and interrupts communication (S58).

When time is necessary for executing the transmission stop process by the transfer node, a process for confirming the transmission stop may be executed, similar to S10, S12, and P8 of FIG. 6.

The control function 140 informs the reception IF management function 130 that the collection information transmission process of the transfer node 300 has been stopped.

The reception IF management function 130 erases the correspondence collection point identifier T1 from the collection point identifier D16 of the reception IF correspondence information D10.

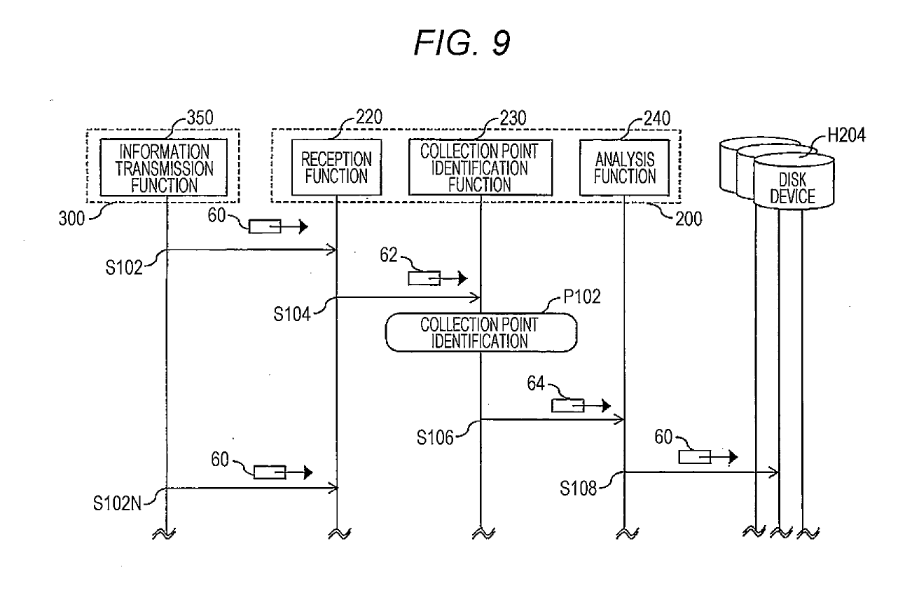

FIG. 9 illustrates an example of a sequence to receive the collection information 60 from the transfer node 300 by the reception function 220.

The information transmission function 350 of the transfer node 300 transmits the collection information 60 when the packet is transmitted/received by the packet transfer function 340 or predetermined time passes (S102 to S102N).

The reception function 220 receives the collection information 60, gives a reception IF identifier to identify a reception IF at which the collection information 60 has arrived to the collection information 60, and delivers the corresponding information as the collection information 62 to the collection point identification function 230 (S104).

The collection point identification function 230 determines the collection point identifier corresponding to the reception IF identifier included in the collection information 62, on the basis of the correspondence of the reception IF identifier D82 and the collection point identifier D84 of the reception IF information D80 stored according to the correspondence information 50, adds the collection point identifier to the collection information 62, and generates the collection information 64 (P102). In addition, the collection point identification function 230 delivers the collection information 64 to the analysis function 240 (S106).

The analysis function 240 erases the added reception IF identifier and collection point identifier from the collection information 64, generates the collection information 60, and stores the collection information 60 in a storage destination such as a predetermined disk device corresponding to the collection point identifier. In this embodiment, the example of the case in which the collection information is stored in the different storage destination for each collection point has been described. However, the collection information may be transmitted to the different destination through the communication network, for each collection point, and a process such as determined visualization may be executed on the collection information, for each collection point.

According to this embodiment, even when the information showing the collection point is not given to the collection information, the collection point can be dynamically set, the collection point can be received by the reception function, and the collection point can be identified.

As a result, when the user acquires the collection information, the user can acquire the collection information from any collection point without changing a physical wiring line and can use the collection information. Therefore, an operation and management cost can be reduced.

### Second Embodiment

A second embodiment is an example of the case in which a transfer node for collection functioning as a transmission node is included in a collection network 290, a transmission port of a transfer node 400 for collection in the collection network 290 is controlled, instead of a transmission port 320 of a transfer node 300, specific collection information is transmitted to a specific reception IF, and a collection node identifies a collection point.

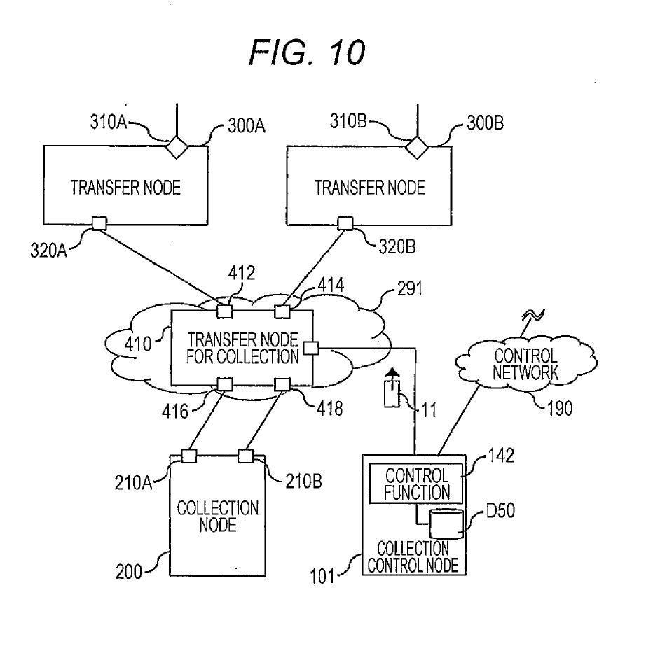

FIG. 10 illustrates a configuration example of a collection network according to the second embodiment.

In FIG. 10, different from the first embodiment, a collection network 291 is included, instead of the collection network 290, and the collection network 291 includes a transfer node 410 for collection, instead of the transfer node 400 for the collection. In addition, different from the first embodiment, a collection control node 101 is included, instead of the collection control node 100.

In the second embodiment, a correspondence relation of a collection point of a transfer node, a transmission port thereof, and a reception port of a transfer node for collection is known and a collection control node manages the correspondence relation.

In this embodiment, the case in which the collection network 291 includes one transfer node 410 for collection is described. However, the collection network 291 may include a plurality of transfer nodes 410 for collection.

The transfer node 410 for the collection includes a function of controlling packet transfer according to a control command of a predetermined format, to transmit packets received by specific ports 412, 414, 416, and 418 from the specific ports 412, 414, 416, and 418. The function is a general function in the transfer node for the collection and an OpenFlow (registered trademark) switch is included, for example.

The transfer node 410 for the collection is connected to a plurality of transfer nodes 300 to 300-N. In addition, each of a plurality of reception IFs 210 to 210-N of a reception function 220 is connected to the transfer node 410 for the collection. When a plurality of transfer nodes for collection exist, the reception IFs 210 to 210-N may be connected to different transfer nodes for collection, respectively.

The collection control node 101 is connected to the transfer node 410 for the collection in the collection network 291, in addition to a control network 190. In addition, the second embodiment is different from the first embodiment in that a control function 142 is included, instead of a control function 140, and transfer node connection information D50 for collection is included, instead of destination reception IF control information D20. The other configuration is the same as the configuration of the first embodiment.

The control function 142 transmits a control command 11 to the transfer node 410 for the collection in the collection network 291 and controls the packet transfer of the transfer node 410 for the collection.

For example, when collection information 60 of a collection point 310A of a transfer node 300A is received by a reception IF 210A of a collection node 200, the control function 142 gives the control command 11 to the transfer node 410 for the collection to transmit packets of the collection information 60 of the collection point 310A received by the reception port 412 of the transfer node 410 for the collection from the transmission port 416. By referring to the managed correspondence relation, it can be known that the packets of the collection information 60 of the collection point 310A are received by the reception port 412 of the transfer node 410 for the collection. As a result, because the transfer node 410 for the collection transmits the collection information 60 received by the reception port 412 from the transmission port 416, the collection node 200 can receive the collection information 60 by the reception IF 210A.

In addition, when the collection information 60 of the collection point 310A of the transfer node 300A is received by the reception IF 210B of the collection node 200, the control function 142 gives the control command 11 to the transfer node 410 for the collection to transmit the packets received by the reception port 412 of the transfer node 410 for the collection from the transmission port 418. As a result, because the transfer node 410 for the collection transmits the collection information 60 received by the reception port 412 from the transmission port 418, the collection node 200 can receive the collection information 60 by the reception IF 210B.

The control command 11 follows a predetermined format by the transfer node 410 for the collection.

In the configuration of the collection network 291 according to the second embodiment, the control function 142 gives the control command 11 to the transfer node 410 for the collection and controls the transmission port for the specific reception port 412 receiving the collection information 60, so that the collection node 200 can control the reception IFs 210 to 210-N receiving the collection information 60.

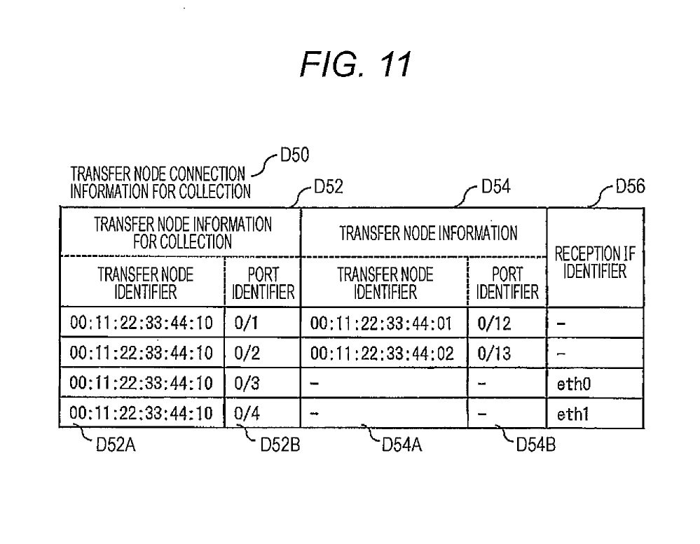

FIG. 11 illustrates items included in the transfer node connection information D50 for the collection. The transfer node connection information D50 for the collection includes transfer node information D52 for collection, transfer node information D54, and a reception IF identifier D56 as items. The transfer node information D52 for the collection includes a transfer node identifier D52A and a transfer node identifier D52B and the transfer node information D54 includes a transfer node identifier D54A and a port identifier D54B.

The transfer node connection information D50 for the collection shows which transmission port of which transmission node each IF included in the transfer node 410 for the collection is connected to or which reception IF of the reception function 220 each IF is connected. In this case, however, correspondence of the collection point 310 and the transmission port 320 of the transfer node 300 is known.

A value of each item included in the transfer node connection information D50 for the collection may be set in advance, may be set manually, or may be set using a known configuration management tool.

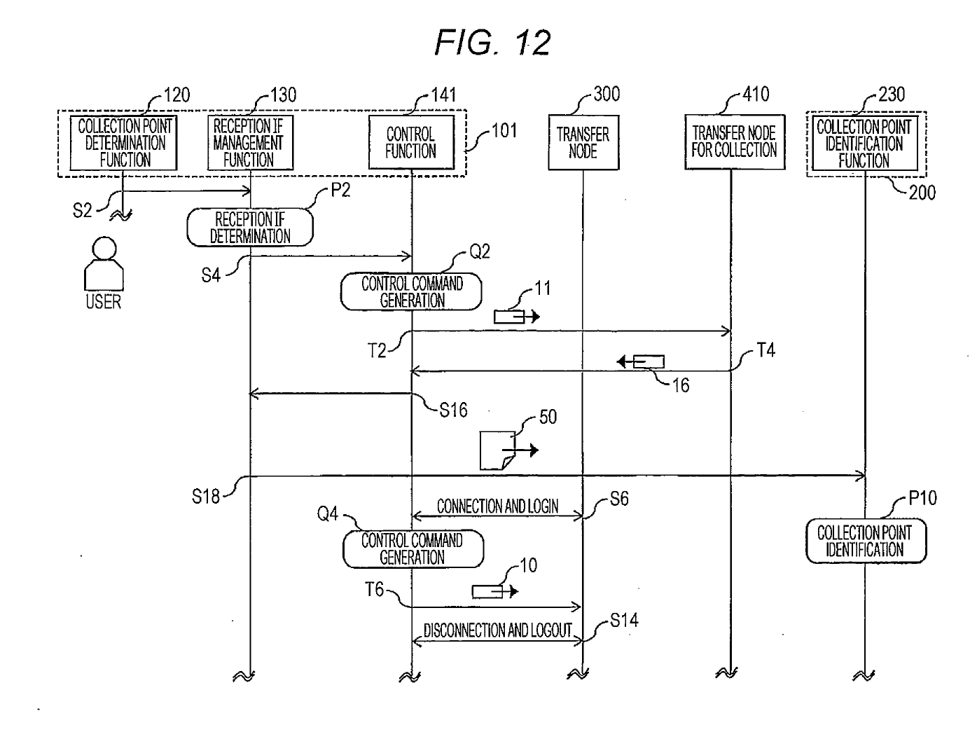

FIG. 12 illustrates an example of a sequence to control the transfer node 410 for the collection to transmit the collection information 60 from the transfer node 300 to the specific reception IF of the reception function 220 by the collection control node 101. The same reference numerals as the reference numerals of FIG. 6 of the first embodiment denote the same processes as the processes of the first embodiment.

Similar to the first embodiment, the control function 142 are informed of a target collection point identifier T1 and a destination reception IF identifier, from the reception IF management function 130, by a process S4.

The control function 142 receives the information and generates a control command 11. Hereinafter, an example of a process Q2 for generating the control command 11 by the control function 142 will be described.

The control function 142 selects a record R1 including the same reception IF identifier D50 as the destination reception IF identifier, in the transfer node connection information D50 for the collection.

The transfer node information D52 for the collection in the record R1 is set as transfer node information E2 for collection, a transfer node identifier D52A of the transfer node information E2 for the collection is set as E2A, and a port identifier D52B is set as E2B.

Next, the control function 142 selects a record R2 including the same transfer node identifier D52A as the transfer node identifier E2A and including the same transfer node identifier D54A as a target transfer node identifier T1N of the target collection point identifier T1.

The port identifier D52B in the record R2 is set as E4B, a transfer node identifier D54A is set as E6A, and a port identifier D54B is set as E6B.

The control function 142 generates the control command 11 to transmit packets received by the port identifier E4B to the port identifier E2B. A description method of the control command follows an OpenFlow protocol, for example.

The control function 142 transmits the control command 11 by the process Q2 to the transfer node 410 for the collection shown by the transfer node identifier E2A (T2).

In this embodiment, an example of the case in which communication is previously established between the control function 141 and the transfer node 410 for the collection is described. However, similar to the first embodiment, the communication may be established explicitly and the login may be executed.

According to the control command 11, the transfer node 410 for the collection changes transfer control of the packets and transmits a confirmation response 16 showing that the change has been completed to the control function 142 (T4).

The control function 142 receives the confirmation response 16 and informs the reception IF management function 130 of completion of the process (S16).

The reception IF management function 130 informs the collection point identification function 230 of the correspondence information 50, similar to the process S18 of the first embodiment.

After the process S16, the control function 142 establishes communication with respect to the transfer node 300 shown by the target transfer node identifier T1N and executes the login, similar to S6 of the first embodiment.

The control function 142 generates a control command 10 to copy packets (configuring traffic) transmitted/received by a target collection port T1PE, understood by an information transmission function 350 of the target transfer node 300, and transmit the packets from a transmission port T2PE shown by the port identifier E6B (Q4).

The control function 142 transmits the generated control command 10 to the transfer node 300 and the transfer node 300 having received the control command 10 starts a collection information transmission process for transmitting collection information 60 acquired by the target collection port T1PE shown by the control command 10 from the target transmission port T2PE shown by the control command 10 (T6).

A sequence to stop the collection information transmission process executed by the transfer node 300 is the same as the sequence of FIG. 8 of the first embodiment.

A sequence to receive the collection information 60 from the transfer node 300 by the reception function 220 is the same as the sequence of the first embodiment.

According to this embodiment, the transfer node 410 for the collection in the collection network 291 is controlled, so that the collection information of the specific collection point can be received by the specific reception IF, and the collection point of the collection information can be identified on the basis of the reception IF.

In this embodiment, it has been assumed that the correspondence of the collection point 310 and the transmission port 320 in the transfer node 300 is fixed. However, the second embodiment may be combined with the first embodiment in which the correspondence of the collection point 310 and the transmission port 320 in the transfer node 300 is controlled. That is, the correspondence of each of the collection point 310 and the transmission port 320 in the transfer node 300 and the reception port and the transmission port in the transfer node 410 for the collection may be controlled by the collection control node 100 or 101 and the collection information of the specific collection point may be received by the specific reception IF.

As a result, the number of transfer nodes for collection and the number of transmission ports of transfer nodes necessary for the collection network can be reduced and a cost can be reduced.

### Third Embodiment

A third embodiment is an example of the case in which, when a destination reception IF is selected, a rule of selecting a reception IF according to an attribute or a communication speed of the reception IF is adopted, instead of selecting a reception IF in which a value of a serial number is smallest.

In the third embodiment, a reception IF management function 133 is included, instead of the reception IF management function 130 according to the first embodiment, and a process for determining the destination reception IF becomes a process (P2-3) to be described below, different from the process (P2) according to the first embodiment. In addition, the reception IF management function 133 includes reception IF management information D10-3, instead of the reception IF correspondence information D10.

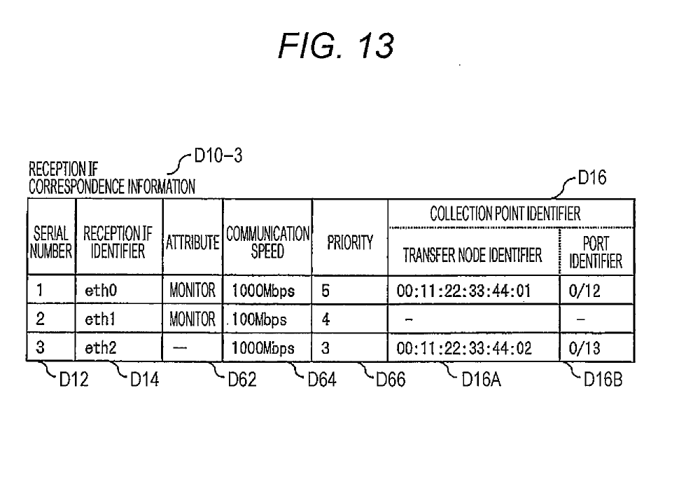

FIG. 13 illustrates an example of items included in the reception IF management information D10-3. The reception IF management information D10-3 includes the reception IF correspondence information D10, an attribute D62, a communication speed D64, and a priority D66 as the items.

The attribute D62 is an identifier to use reception IFs 210 to 210-N for collection information of a specific use. The attribute D62 is set manually in advance according to a use of the reception IF. When the use of the reception IF is not limited, the attribute D62 is not set (unattributed).

The communication speed D64 is a fixed value determined according to a type of the reception IF and shows a communication speed of the reception IF. The communication speed D64 may be set manually in advance according to the type of the reception IF and may be set automatically by a configuration management tool.

The priority D66 shows the priority of each of the reception IFs 210 to 210-N when the reception IF is selected as the destination and when a value of the priority is large, the priority is high. The priority D66 may be set manually in advance or may be calculated and set by a reception IF management function 132. A calculation method is to use the number of central processing units (CPUs) allocated to process the packets received by the reception IF. By the calculation method, the high priority can be given to the reception IF in which the process is fast.

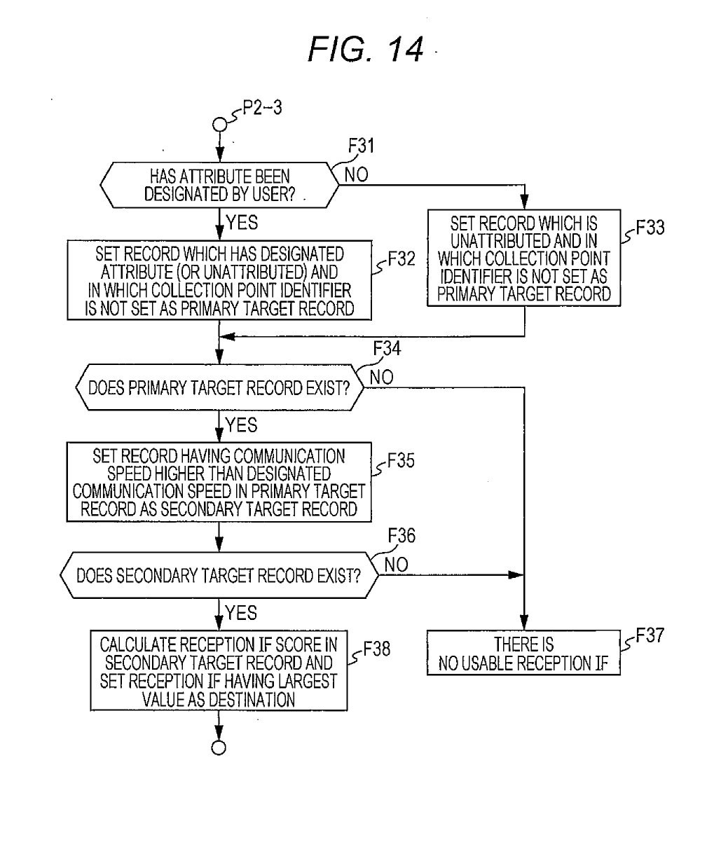

FIG. 14 illustrates an example of a process P2-3 for determining the destination reception IF by the reception IF management function 133. The user U10 designates the collection point through the input/output terminal U12, by S2 of FIG. 6 of the first embodiment. However, in the third embodiment, the attribute D62 and the communication speed D64 may be designated in addition to the collection point and the reception IF management function 133 may be informed of the collection point, the attribute, and the communication speed.

In the reception IF management function 133, the collection point identifier D16, the attribute D62 (or non-designation), and the communication speed D64 (or non-designation) are designated in S2.

The reception IF management function 133 determines whether the attribute D62 has been designated (F31). If the attribute D62 is designated (YES in F31), a record which includes the attribute designated in the reception IF correspondence information D10-3 (or unattributed) and in which the collection point identifier D16 is not set is set as a primary target record (F32).

If the attribute D62 is not designated (NO in F31), a record which is unattributed and in which the collection point identifier D16 is not set is set as the primary target record (F33).

When the primary target record does not exist (NO in F34), there is no usable reception IF corresponding to the attribute designated by the user. For this reason, the collection point designated by the user cannot be set.

When the primary target record exists (YES in F34), a record including the communication speed D64 equal to or more than the communication speed designated in the primary target record is set as a secondary target record (F35). When the communication speed D64 is not designated by the user U10, all of the primary target records are set as the secondary target records.

When the secondary target record does not exist (NO in F36), a usable reception IF satisfying the communication speed designated by the user does not exist. For this reason, the collection point designated by the user cannot be set.

When the secondary target record exists (YES in F36), a reception IF score is calculated and a reception IF having a highest reception IF score in the secondary target record is set as a destination reception IF (F38). The reception IF score is calculated such as ((α×communication speed D64)+(β×priority D66)) using predetermined constants α and β, on the basis of the communication speed D64 and the priority D66. When a plurality of reception IFs have the same reception IF score, a reception IF in which a value of a serial number is smallest is selected, similar to the first embodiment.

According to this embodiment, the user designates the attribute of the collection information and the communication speed and the collection information can be transmitted to the reception IF satisfying these essential factors.

As a result, the attribute is designated, so that the user can allocate a reception IF having high process performance exclusively to a use of a high priority (for example, monitoring of traffic, that is, packet communication). Designating the communication speed can prevented the reception interface from dropping the packets that is caused by being transmitted of too much collection information more than the process performance of the reception IF.

This embodiment can be combined with the first embodiment or the second embodiment.

### Fourth Embodiment

In a fourth embodiment, a collection point can be identified even when collection information from a plurality of collection points is aggregated and is received by one reception IF.

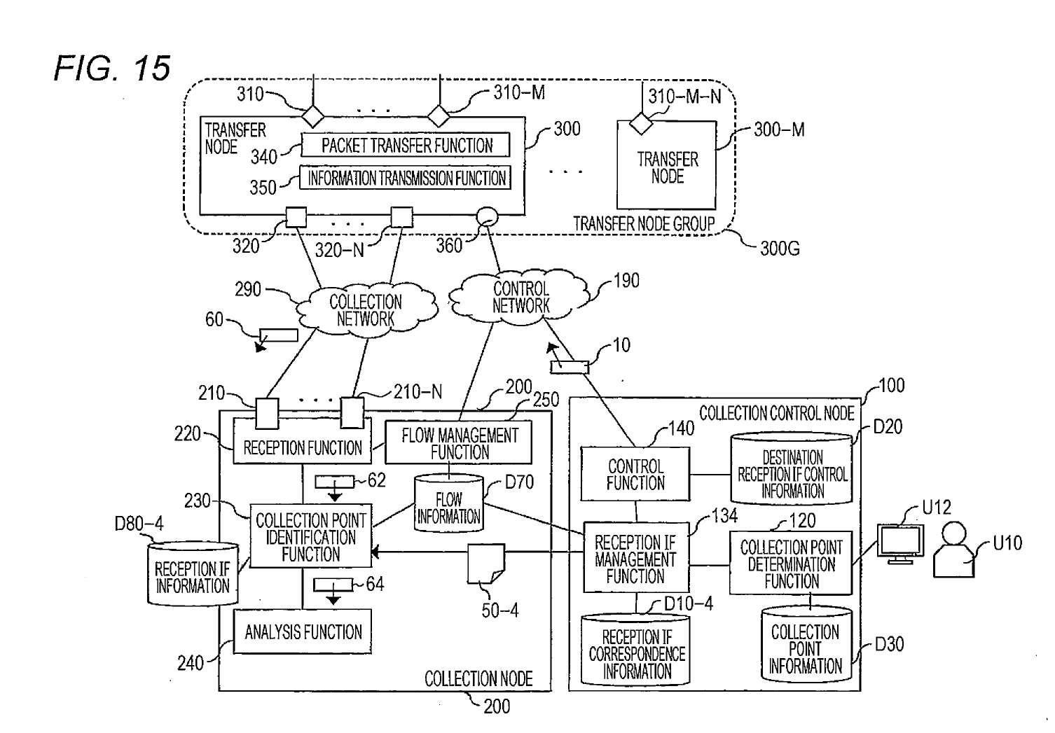

As illustrated in FIG. 15, a collection node 200 according to the fourth embodiment includes, in addition to the first embodiment, a flow management function 250 and flow information D70. In addition, a collection point identification function 234, a reception IF management function 134, reception IF correspondence information D10-4, correspondence information 50-4, and reception IF information D80-4 are different from the content of the first embodiment.

The flow management function 250 is a function of storing which communication flow is used in each of collection points 310 to 310-N in the flow information D70. The communication flow is a combination of a transmission origin IP address, a transmission destination IP address, and a transmission destination port of a packet, for example. Information of the communication flow can be acquired from flow information provided by transfer nodes 300 to 300-N through a control network 190. The flow information is information obtained using known traffic monitoring technology such as NetFlow or IETF RFC3176, for example.

The reception IF correspondence information D10-4 is different from the reception IF correspondence information D10 according to the first embodiment in that a set of one serial number D12 and a reception IF identifier D14 includes a plurality of collection point identifiers D16.

The correspondence information 50-4 is different from the correspondence information 50 according to the first embodiment in that one reception IF identifier includes a plurality of collection point identifiers. Likewise, in the reception IF information D80-4, one reception IF identifier includes a plurality of collection point identifiers.

A configuration of a control command in this embodiment is the same as the configuration in the first embodiment.

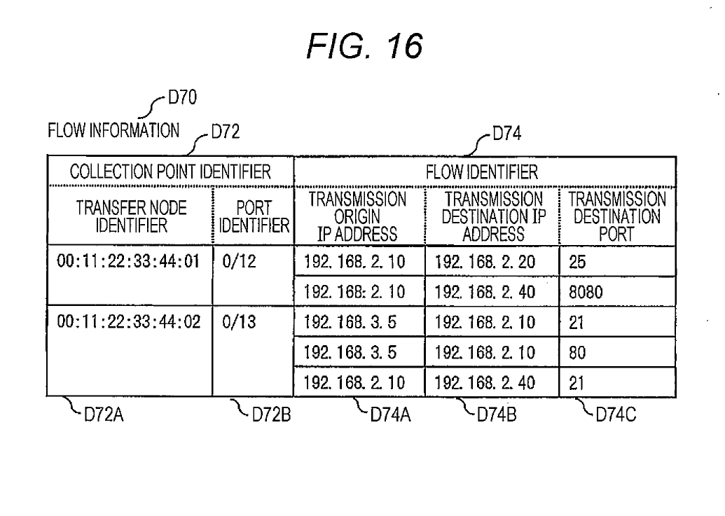

FIG. 16 illustrates an example of items included in the flow information D70. The flow information D70 includes a collection point identifier D72 including a transfer node identifier D72A and a port identifier D72B and a plurality of flow identifiers D74 for one collection point identifier D72 as the items. The flow identifier includes a transmission origin IP address D74A, a transmission destination IP address D74B, and a transmission destination port D74C.

In the flow information D70, when the plurality of collection point identifiers D72 do not have the same flow identifier D74, collection information acquired from a plurality of collection points can be aggregated (that is, even when the collection information in the plurality of collection points is received by one reception IF, the collection information can be identified).

The flow information D70 is set previously by the flow management function 250 as described above.

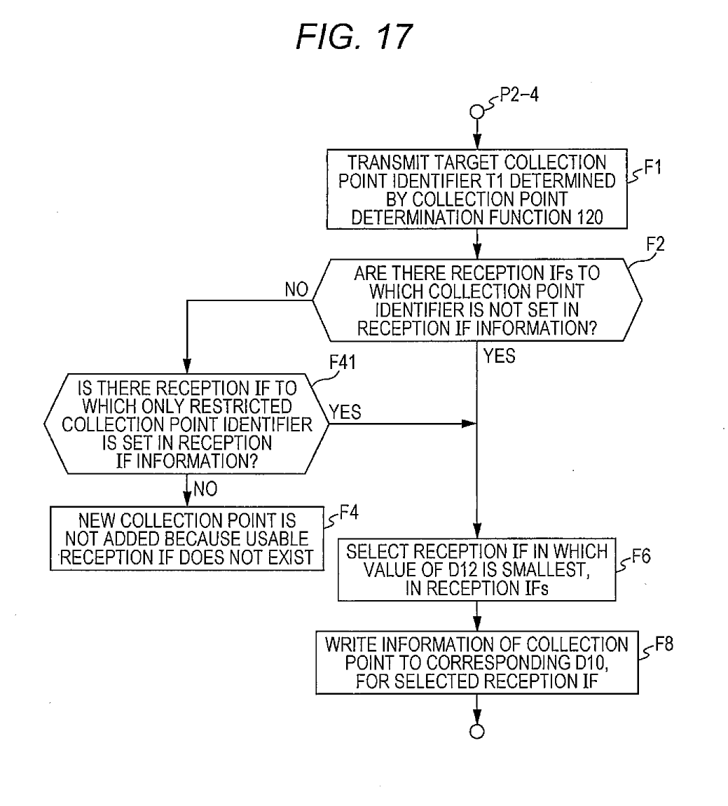

FIG. 17 illustrates an example of a process P2-4 when the reception IF management function 134 determines a destination reception IF and corresponds to the process P2 of the first embodiment. The reception IF management function 134 is informed of a target collection point identifier T1, from the collection point determination function 120 (F1). When the reception IF identifier D14 to which the collection point identifier D16 is not set exists in the reception IF information D10-4, the process after F6 is executed, similar to the first embodiment.

When the reception IF identifier D14 to which the collection point identifier D16 is not set does not exist in the reception IF information D10-4 (NO in F2), it is determined whether the reception IF identifier D14 exists, to which a collection point are set, the collection point being aggregatable with a collection point shown by the target collection point identifier T1. If the reception IF identifier D14 does not exist (NO in F41), it is determined that a usable reception IF does not exist (F4). If the reception IF identifier D14 exists (YES in F41), the process after F6 is executed, similar to the first embodiment.

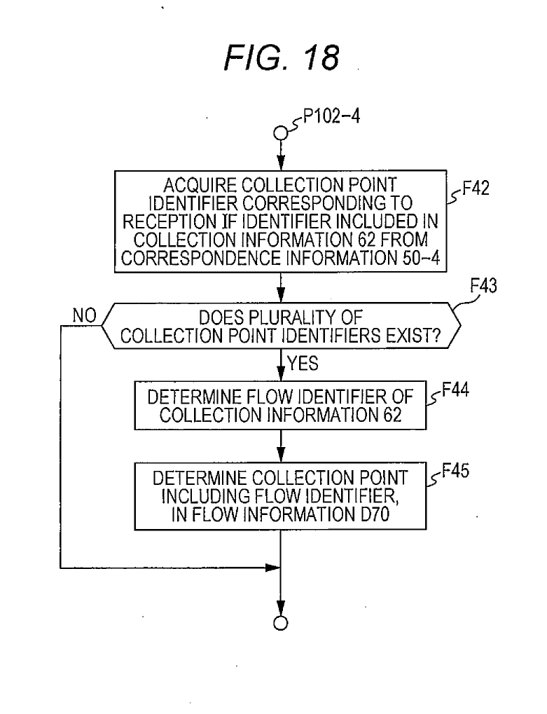

FIG. 18 illustrates an example of a process P102-4 for identifying the collection point by the collection point identification function 234 and corresponds to P102 of FIG. 9 in the first embodiment.

Similar to S104 of FIG. 9 of the first embodiment, the collection point identification function 234 receives collection information 62 obtained by adding a reception IF identifier to collection information 60, from the reception function 220. The collection point identification function 234 determines a plurality of collection points 51-4 corresponding to reception IFs of the collection information 62, on the basis of a set of a reception IF identifier and a collection point identifier included in the reception IF information D80-4 (F42). When one corresponding collection point 51-4 exists (NO in F43), the collection point identifier of the collection point is added to the collection information 62 and the collection information 64 is configured.

When a plurality of collection points 51-4 exist (YES in F43), the collection point identification function 234 acquires a transmission origin IP address, a transmission destination IP address, and a transmission destination port number included in the collection information 62 and configures a flow identifier 52-4 (F44). A value such as the transmission destination IP address is a part of an IP header or a TCP header of the collection information 62 and can be acquired by known technology.

The collection point identification function 234 sets the collection point included in the collection point 51-4 among the collection points including the flow identifier 52-4 generated in the flow information D70 as the collection point of the collection information 62 (F45), adds the collection point identifier of the collection point to the collection information 62, and configures the collection information 64.

According to this embodiment, the collection information from the plurality of aggregatable connection points can be received by one reception IF and the collection point can be identified by the reception IF and the communication flow. As a result, the number of reception IFs of the reception function can be reduced and a cost can be reduced.

Each embodiment described above can be combined with one or more other embodiments.

Although the present disclosure has been described with reference to exemplary embodiments, those skilled in the art will recognize that various changes and modifications may be made in form and detail without departing from the spirit and scope of the claimed subject matter.

1. A traffic information collection system in which a collection node collecting collection information regarding traffic acquired by nodes on a network identifies a collection point of the collection information, comprising:
a transmission node that transmits the collection information from a designated transmission port; and
a collection control node, wherein
the collection control node manages a connection relation of the transmission port of the transmission node and a reception IF of the collection node,
the collection control node determines the reception IF of the collection node receiving the collection information acquired at a designated collection point of any node,
the collection control node designates the transmission port connected to the determined reception IF with respect to the transmission node and outputs the collection information from the designated transmission port, and
the collection control node informs the collection node of correspondence information of the collection point and the reception IF.

2. The traffic information collection system according to claim 1, wherein
the transmission node is a transfer node to acquire the collection information, and
the collection control node transmits a control command to designate the collection point and the transmission port to transmit the collection information acquired at the collection point to the transfer node.

3. The traffic information collection system according to claim 1, wherein
the collection information is acquired by a transfer node connected to a reception port of the transmission node,
the transmission node is a transfer node for collection on a collection network connecting the transfer node and the collection node,
the collection control node manages a connection relation of the collection point of the transfer node, the transmission port to transmit the collection information acquired at the collection point, and a reception port of the transfer node for the collection, and
the collection control node transmits a control command to designate the reception port of the transfer node for the collection connected to the transmission port to output the collection information acquired at the collection point by the transfer node and the transmission port connected to the determined reception IF of the collection node to the transfer node for the collection.

4. The traffic information collection system according to claim 1, wherein
the collection control node selects one reception IF satisfying a designated condition from one or more reception IFs to which reception of the collection information is not set, according to a predetermined rule, in the determination of the reception IF of the collection node.

5. The traffic information collection system according to claim 4, wherein
the designated condition is a communication speed or an attribute and the communication speed.

6. The traffic information collection system according to claim 5, wherein
the collection control node associates the attribute, the communication speed, and a priority and stores the association, for each reception IF, and
the collection control node calculates a reception IF score of the reception IF satisfying the designated condition, on the basis of the communication speed and the priority, and selects a reception IF having a highest reception IF score.

7. The traffic information collection system according to claim 1, wherein
the collection node previously stores a communication flow of the traffic passing through the collection point as flow information,
the collection control node specifies collection information of a plurality of collection points received by one reception IF, on the basis of the flow information,
the collection control node controls the transmission port of the transmission node, such that the specified collection information of the plurality of collection points includes a communication flow identifier to identify the communication flow and is received by the same reception IF of the collection node, and
the collection node identifies the collection point, on the basis of the communication flow identifier included in the collection information and the flow information.

8. The traffic information collection system according to claim 1, wherein when there is no reception IF to which reception of the collection information is not set, in the determination of the reception IF,
the collection node previously stores a communication flow of the traffic passing through the collection point as flow information,
the collection control node specifies collection information of a plurality of collection points received by one reception IF, on the basis of the flow information,
the collection control node controls the transmission port of the transmission node, such that the specified collection information of the plurality of collection points includes a communication flow identifier to identify the communication flow and is received by the same reception IF of the collection node
the collection node identifies the collection point, on the basis of the communication flow identifier included in the collection information and the flow information.

9. A collection control node used for a traffic information collection system in which a transmission node transmits collection information regarding traffic acquired by nodes on a network from a designated transmission port and a collection node collects the transmitted collection information and identifies a collection point of the collection information, wherein
a connection relation of the transmission port of the transmission node and a reception IF of the collection node is managed,
the reception IF of the collection node receiving the collection information acquired at a designated collection point of any node is determined,
the transmission port connected to the determined reception IF is designated with respect to the transmission node and the collection information is output from the designated transmission port, and
the collection node is informed of correspondence information of the collection point and the reception IF.

10. The collection control node according to claim 9, wherein
when the transmission node is a transfer node to acquire the collection information, a control command to designate the collection point and the transmission port to transmit the collection information acquired at the collection point to the transfer node is transmitted to the transfer node.

11. The collection control node according to claim 9, wherein
the collection information is acquired by a transfer node connected to a reception port of the transmission node, and
when the transmission node is a transfer node for collection on a collection network connecting the transfer node and the collection node, a connection relation of the collection point of the transfer node, the transmission port to transmit the collection information acquired at the collection point, and a reception port of the transfer node for the collection is managed and a control command to designate the reception port of the transfer node for the collection connected to the transmission port to output the collection information acquired at the collection point by the transfer node and the transmission port connected to the determined reception IF of the collection node is transmitted to the transfer node for the collection.

12. The collection control node according to claim 9, wherein
one reception IF satisfying a designated condition is selected from one or more reception IFs to which reception of the collection information is not set, according to a predetermined rule, in the determination of the reception IF of the collection node.

13. The collection control node according to claim 12, wherein
the designated condition is a communication speed or an attribute and the communication speed.

14. The collection control node according to claim 13, wherein
the attribute, the communication speed, and a priority are associated and stored for each reception IF, and
a reception IF score of the reception IF satisfying the designated condition is calculated on the basis of the communication speed and the priority and a reception IF having a highest reception IF score is selected.

15. The collection control node according to claim 9, wherein
the collection node previously stores a communication flow of the traffic passing through the collection point as flow information,
collection information of a plurality of collection points received by one reception IF is specified on the basis of the flow information,
the transmission port of the transmission node is controlled such that the specified collection information of the plurality of collection points includes a communication flow identifier to identify the communication flow and is received by the same reception IF of the collection node, and
the collection node identifies the collection point, on the basis of the communication flow identifier included in the collection information and the flow information.

16. The collection control node according to claim 15, wherein
a process according to claim 15 is executed when there is no reception IF to which reception of the collection information is not set, in the determination of the reception IF.
